(19) United States
(12) Patent Application Publication
(10) Pub. No.: US 2011/0063402 A1
(43) Pub. Date: Mar. 17, 2011

(54) METHOD OF FORMING AND MANAGING OF TEMPLATE, TEMPLATE, AND TEMPLATE FORMING AND MANAGING DEVICE

(76) Inventor: Kazuki HAGIHARA, Kanagawa (JP)

(21) Appl. No.: 12/879,955

(22) Filed: Sep. 10, 2010

(30) Foreign Application Priority Data
Sep. 17, 2009 (JP) 2009-215247

(51) Int. Cl. B41J 2/47

(52) U.S. Cl. 347/225

(57) ABSTRACT

A method of forming and managing a template according to the embodiment includes forming a child template using a parent template and producing managing information about the parent template; and forming a mark including the managing information in the child template.

### CROSS-REFERENCE TO RELATED APPLICATIONS

This application is based upon and claims the benefit of priority from prior Japanese Patent Application No. 2009-215247, filed on Sep. 17, 2009, the entire contents of which are incorporated herein by reference.

### FIELD

Embodiments described herein relate generally to the method of forming and managing of template, template, and template forming and managing device.

### BACKGROUND

As a conventional technique, a transfer device is known, that includes a mold in which a bar-code including distinguishing information is printed, a bar-code reader configured to read out the bar-code printed in the mold, a database in which mold specific data corresponding to the distinguishing information are stored, and a controller configured to read out the mold specific data corresponding to the distinguishing information read out by the bar-code reader from the database.

In the mold specific data, data of parallelism between a mounting surface of the mold and a pattern surface are stored. Since the controller of the transfer device adjusts an inclination between a wafer and the mold based on the mold specific data, an exact alignment can be carried out.

### BRIEF DESCRIPTION OF THE DRAWINGS

FIG. 1 is an explanatory view schematically showing a composition of a template forming and managing system according to a first embodiment;

FIG. 2 is a block diagram schematically showing a composition of the first imprint device according to a first embodiment;

FIG. 3 is an explanatory view schematically showing imprint information according to the first embodiment;

FIG. 4 is a cross-sectional view schematically showing the primary portion of a child template according to the first embodiment;

FIG. 5 is an explanatory view schematically showing managing information included in a mark according to the first embodiment;

FIG. 6 is a block diagram schematically showing a composition of a managing device according to the first embodiment;

FIG. 7 is an explanatory view schematically showing system managing information according to the first embodiment;

FIGS. 8A to 8F are cross-sectional views schematically showing the primary portions of manufacturing processes of a parent template according to the first embodiment;

FIGS. 9A to 9F are cross-sectional views schematically showing the primary portions of manufacturing processes of the child template according to the first embodiment;

FIGS. 10A to 10E are cross-sectional views schematically showing the primary portions of processes of manufacturing method of a semiconductor device according to the first embodiment;

FIG. 11 is an explanatory view schematically showing a relationship between the parent template and the child template according to the first embodiment;

FIG. 12 is a flowchart schematically showing a method of forming and managing a template according to the first embodiment;

FIG. 13 is an explanatory view schematically showing a relationship between the parent template and the child template according to a second embodiment;

FIG. 14 is a flowchart schematically showing a method of forming and managing a template according to the second embodiment;

FIG. 15 is an explanatory view schematically showing a relationship between the parent template and the child template according to a third embodiment;

FIG. 16 is a flowchart schematically showing a method of forming and managing a template according to the third embodiment;

FIG. 17 is an explanatory view schematically showing a relationship between the parent template and the child template according to a fourth embodiment; and

FIG. 18 is a flowchart schematically showing a method of forming and managing a template according to the fourth embodiment;

### DETAILED DESCRIPTION

A method of forming and managing a template according to the embodiment includes forming a child template using a parent template and producing managing information about the parent template; and forming a mark including the managing information in the child template.

### First Embodiment

### Composition of Template Forming and Managing System

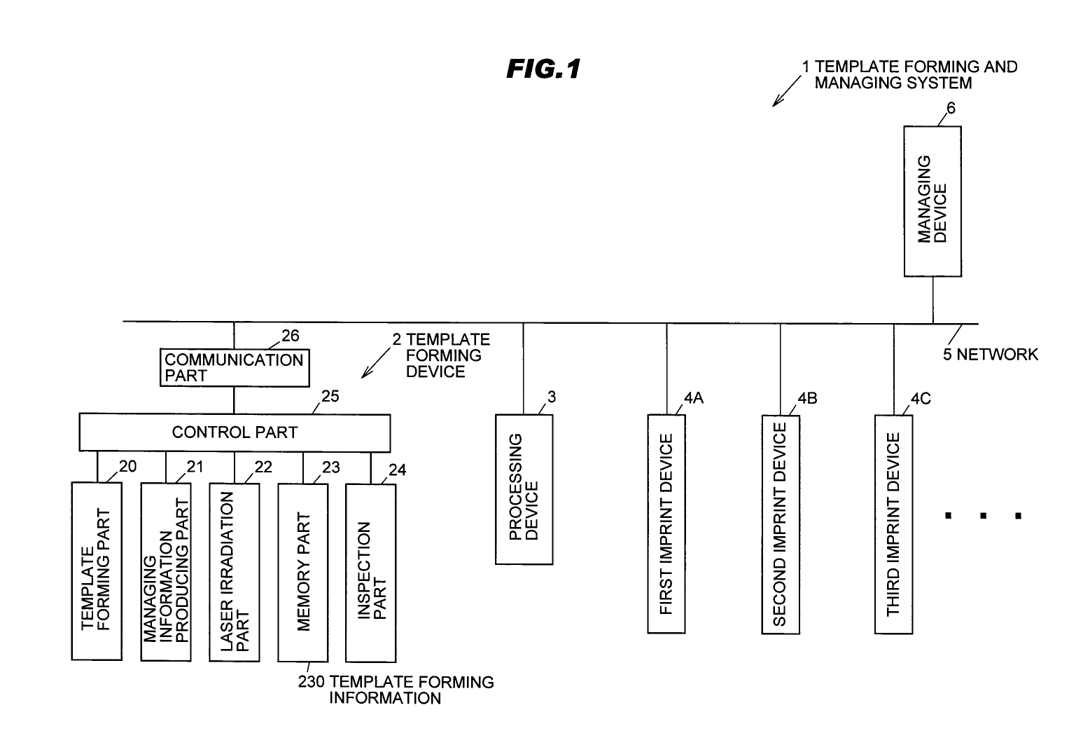

FIG. 1 is an explanatory view schematically showing a composition of a template forming and managing system according to a first embodiment.

As shown in FIG. 1, the template forming and managing system 1 is roughly configured to include a template forming device 2, a processing device 3, imprint devices 4A to 4C, a network 5 and a managing device 6 as a managing part connected to the template forming device 2, the processing device 3 and the imprint devices 4A to 4C via the network 5. Hereinafter, a case that the first to the third imprint devices 4A to 4C are connected to the managing device 6 via the network 5 will be explained as an example of the template forming and managing system 1.

### Composition of Template Forming Device

The template forming device 2 is configured to be used for forming a parent template to become a mold and child templates formed by using the parent template. The template forming device 2 is roughly configured to include a template forming part 20, a managing information producing part 21, a laser irradiation part 22 as a mark forming part, a memory part 23, an inspection part 24, a control part 25 and a communication part 26.

The template forming part 20 is configured, for example, to include a composition of an imprint processing part of an imprint device described below, and to form the parent template and the child templates.

The managing information producing part 21 is configured, for example, to produce managing information described below.

The laser irradiation part 22 is configured, for example, to form a mark described below at predetermined places of the parent template and the child templates. The laser irradiation part 22 is configured, for example, to output a laser light 220 that is a ArF excimer laser having a wavelength of 193 nm.

The memory part 23 is configured, for example, to include a hard disk drive (HDD) and to store template forming information 230. The template forming information 230 includes, for example, identification information, a manufacturing date, a kind of processing treatment and formed patterns of the parent template and the child templates formed, and number of processing applied to the parent template.

Here, the identification information means, for example, names given to the parent template and the child templates formed. The manufacturing date means, for example, time and date when the parent template and the child templates are manufactured. The kind of processing treatment means, for example, a kind of processing treatment when the parent template is manufactured. The formed pattern means, for example, a kind of pattern formed in the child template. The number of processing applied to the parent template means, for example, number of processing that is carried out by the processing device 3.

The inspection part 24 is configured, for example, to inspect the parent template and the child templates manufactured by the template forming part 20.

The control part 25 is configured, for example, to include a central processing unit (CPU), a random access memory (RAM) and a read only memory (ROM).

The communication part 26 is configured, for example, to be connected to the network 5.

### Composition of Processing Device

The processing device 3 is configured, for example, to be connected to the managing device 6 via the network 5, and to carry out cleaning treatment, defect inspection and the like of the parent template or the child templates. The processing device 3 is configured to transmit the kind of treatment applied to the parent template or the child templates to the template forming device 2 via the network 5, associating with identification information of the template to which the treatment is applied.

### Composition of Imprint Device

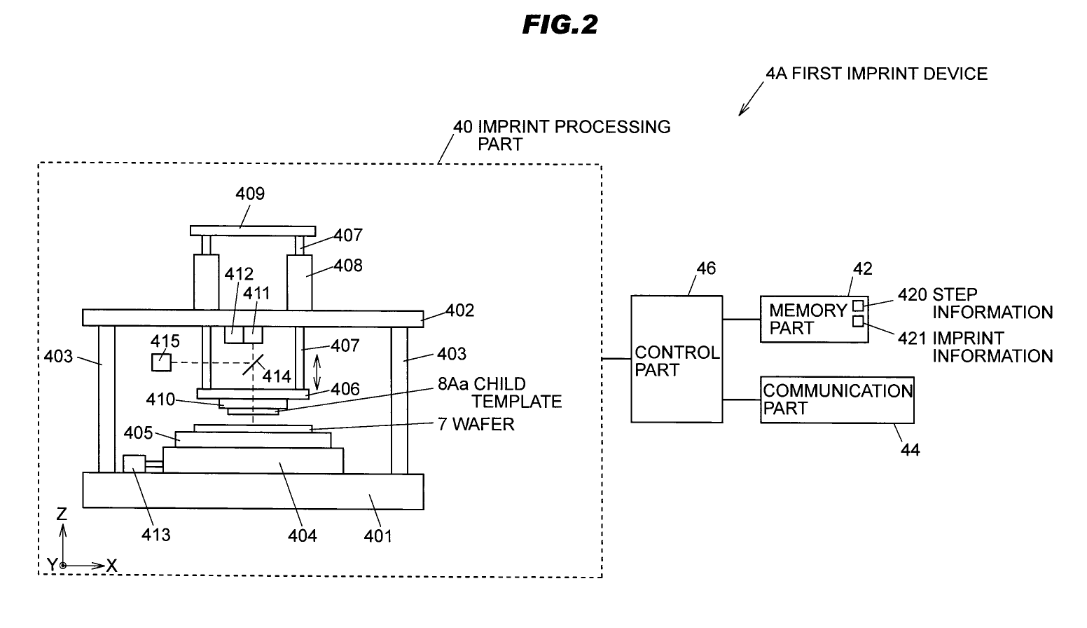

FIG. 2 is a block diagram schematically showing a composition of the first imprint device according to a first embodiment. The first to third imprint devices 4A to 4C are configured to be premised that they have the same composition, so that a composition of the first imprint device 4A will be explained. Further, X, Y and Z in FIG. 2 show directions perpendicular to each other. In addition, the first imprint device 4A explained below is configured to allow the child template 8Aa to move in a direction of the wafer 7, but not limited to this, it can be also configured to allow the wafer 7 to move in a direction of the child template 8Aa and to allow both of them to move.

Here, the child template 8Aa means a template set to the first imprint device 4A. In addition, the wafer 7 as a base workpiece is, for example, a Si based substrate including Si as a main component.

As shown in FIG. 2, the first imprint device 4A is roughly configured to include an imprint processing part 40 configured to carry out an imprint processing, a memory part 42 configured to store step information 420, imprint information 421 and the like, a communication part 44 as a transmitting part configured to transmit the imprint information 421, and a control part 46 configured to control the imprint processing part 40, the memory part 42 and the communication part 44.

As shown in FIG. 2, the imprint processing part 40 is configured to have a structure that a base plate 401 and a top board 402 are combined by a support rod 403. On the base plate 401, an XY stage 404 is disposed and on the XY stage 404, a chuck 405 configured to fix the wafer 7 by electrostatic adsorption, vacuum adsorption or the like is disposed.

In the top board 402, a plurality of actuators 408 configured to allow an upper stage 406 to move up and down in a direction of the Z axis by a plurality of guide bars 407 are mounted. Upper end portions of the guide bars 407 are combined by a guide plate 409. The XY stage 404 is configured to allow the chuck 405 to move in directions of the X axis and the Y axis.

In the upper stage 406, a template chuck 410 configured to fix the child template 8Aa by electrostatic adsorption, vacuum adsorption or the like is mounted. In addition, in a lower surface of the top board 402, a irradiation part 411 configured to irradiate ultraviolet light to a resist material formed on the wafer 7 via the upper stage 406, the template chuck 410 and the child template 8Aa, and a reading part 412 as an obtaining part configured to read out a mark described below formed in the child templates 8Aa are disposed. In the upper stage 406 and the template chuck 410, openings configured to allow ultraviolet light irradiated from the irradiation part 411 to pass through are formed. In addition, the reading part 412 is configured to read out the mark described below of the child template via the openings.

The actuator 413 is mounted in the XY stage 404 and is configured to allow the XY stage 404 to move in directions of the X axis and the Y axis when the child template 8Aa and the wafer 7 are optically aligned with each other.

Further, a rear surface of the child template 8Aa can be pressed to a side of the wafer 7 via a fluid (liquid or gas). Due to this, an influence of flatness of the rear surface of the child template 8Aa can be reduced.

In addition, the imprint processing part 40 has a half mirror 414 between the irradiation part 411 and the upper stage 406, and has an inspection part 415 configured to inspect the wafer 7 via the half mirror 414.

The memory part 42 is configured, for example, to include a HDD. The step information 420 is, for example, information about steps of manufacturing method of a semiconductor device and parameters of each step.

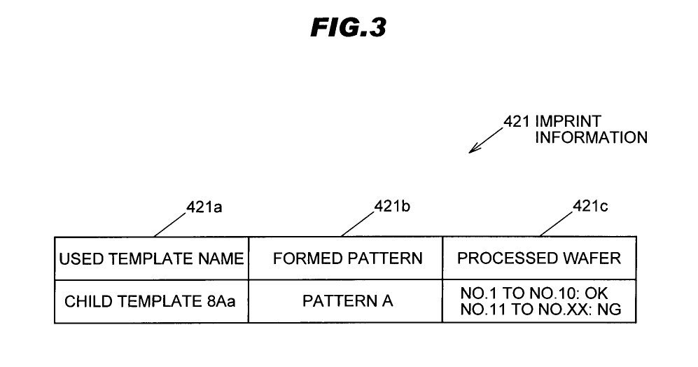

The FIG. 3 is an explanatory view schematically showing imprint information according to the first embodiment. As shown in FIG. 3, the imprint information 421 is roughly configured to include, for example, a used template name 421a, a formed pattern 421b and a processed wafer 421c.

The used template name 421a is, for example, identification information given to every child template 8Aa so as to identify the child templates set to the imprint processing part 40.

The formed pattern 421b is, for example, information about patterns such as wiring pattern formed in the child templates.

The processed wafer 421c is, for example, information about an inspection result by the inspection part 415 after the processing that uses the child template set to the imprint processing part 40 is completed. “No. 1” in FIG. 3 shows, for example, a wafer obtained first after the processing is completed. In addition, “No. 1 to No. 10: OK” in FIG. 3 shows that wafers obtained first to tenth after the processing is completed are good products. In addition, “No. 11 to No. xx: NG” in FIG. 3 shows that wafers obtained eleventh to xxth after the processing is completed are defective products.

The communication part 44 is configured, for example, to be connected to the managing device 6 via the network 5 and to transmit the imprint information 421 to the managing device 6 via the network 5.

The control part 46 is configured, for example, to include a CPU, a RAM, a ROM and the like, and to control the irradiation part 411, the reading part 412, and the actuators 408, 413, so as to control manufacturing steps of the semiconductor device based on the step information stored in the memory part 42.

### Composition of Child Template

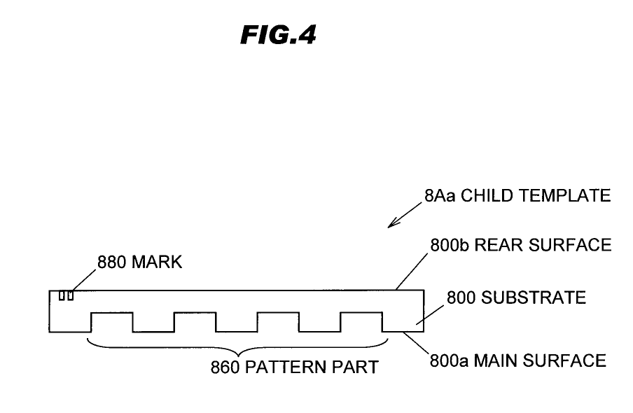

FIG. 4 is a cross-sectional view schematically showing the primary portion of a child template according to the first embodiment. The child template 8Aa is, for example, one of products produced from the parent template 8A described below. As shown in FIG. 4, the child template 8Aa is formed of, for example, a substrate 800 that is a transparent substrate. In the substrate 800, for example, a pattern part 860 and a mark 880 are formed.

The substrate 800 is, for example, a Si based substrate including Si as a main component.

The pattern part 860 is formed, for example, in a side of a main surface 800a of the substrate 800. The pattern part 860 has a pattern formed of a plurality of concave and convex portions.

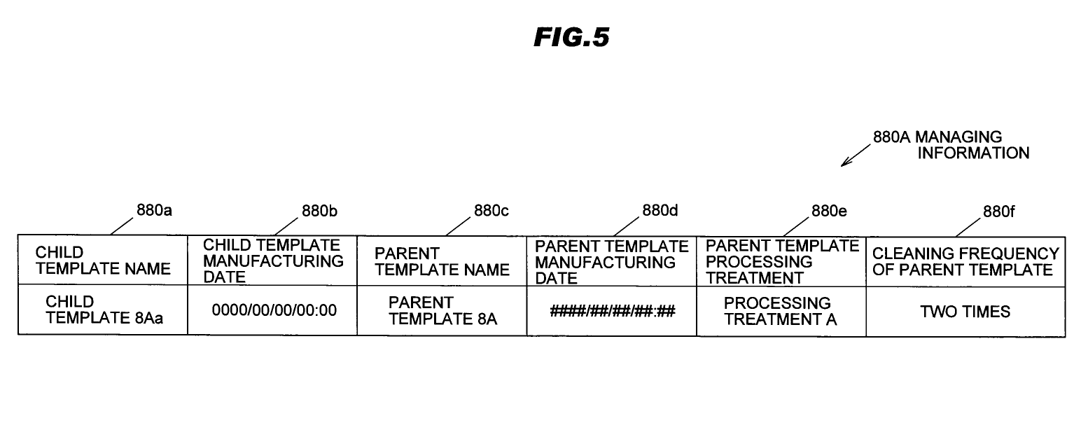

FIG. 5 is an explanatory view schematically showing managing information included in a mark according to the first embodiment. The mark 880 are formed, for example, in a side of a rear surface 800b of the substrate 800 and in a region out of the pattern part 860.

The mark 880 are formed of, for example, a one-dimensional code that information is aligned in a transverse direction, a two dimensional code that information is aligned in a longitudinal direction and a transverse direction or a picture image. The mark 880 are configured, for example, to be read out by the reading part 412 and be processed by the control part 46, so as to become managing information 880A shown in FIG. 5. Further, the mark 880 can be also formed in a side surface of the child template 8Aa.

The managing information 880A is information mainly relating to the parent template. The managing information 880A is formed by the managing information producing part 21 of the template forming device 2. The template forming device 2 forms the child templates 8Aa, and forms the managing information 880A as the mark 880 in the child templates 8Aa by the laser irradiation part 22.

In addition, as shown in FIG. 5, the managing information 880A is roughly configured to include a child template name 880a, a child template manufacturing date 880b, a parent template name 880c, a parent template manufacturing date 880d, a parent template processing treatment 880e and a cleaning number of parent template 880f.

The child template name 880a is, for example, identification information configured to identify the child template.

The child template manufacturing date 880b is, for example, information (time and date information) about time and date when the child templates are manufactured.

The parent template name 880c is, for example, identification information configured to identify the parent template used when the child templates are manufactured.

The parent template manufacturing date 880d is, for example, information (time and date information) about time and date when the parent template is manufactured.

The parent template processing treatment 880e is, for example, information (processing treatment information) about a processing treatment carried out when the parent template is manufactured.

The cleaning number of parent template 880f is, for example, information (number of cleaning information) about cleaning number of the parent template used when the child templates are manufactured. The cleaning of the parent template is carried out in the processing device 3. Further, the cleaning number of parent template 880f can be number of processing other than cleaning applied to the parent template in the processing device 3.

### Composition of Managing Device

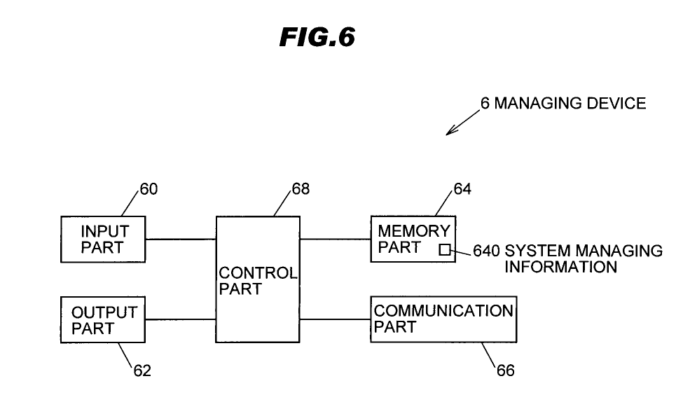

FIG. 6 is a block diagram schematically showing a composition of a managing device according to the first embodiment. As shown in FIG. 6, the managing device 6 is roughly configured to include an input part 60 configured to be connected to an input device such as a keyboard, an output part 62 configured to be connected to an external device such as a monitor, a memory part 64 configured to be formed of a HDD or the like and to store system managing information 640, a communication part 66 configured to be connected to the template forming device 2, the processing device 3 and a plurality of the imprint devices via the network 5, and a control part 68.

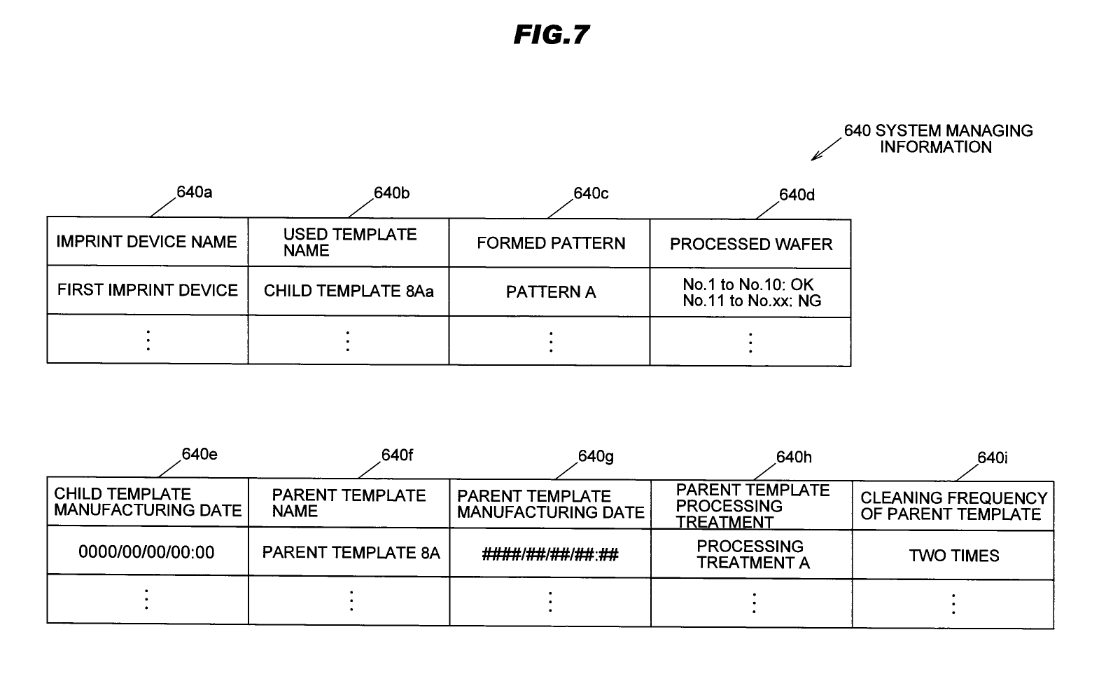

FIG. 7 is an explanatory view schematically showing system managing information according to the first embodiment. The system managing information 640 is configured to include the imprint information 421 of every imprint device connected to the managing device 6 via the network 5, and the managing information 880A read out from the child template set to the imprint device.

As shown in FIG. 7, the system managing information 640 is roughly configured, for example, to include an imprint device name 640a, a used template name 640b, a formed pattern 640c, a processed wafer 640d, a child template manufacturing date 640e, a parent template name 640f, a parent template manufacturing date 640g, a parent template processing treatment 640h, and a cleaning number of parent template 640i.

The imprint device name 640a is, for example, identification information of the imprint device connected to the managing device 6 via the network 5.

The used template name 640b, the formed pattern 640c and the processed wafer 640d are corresponding to the used template name 421a, the formed pattern 421b and the processed wafer 421c of the imprint information 421 of the imprint device.

The child template manufacturing date 640e, the parent template name 640f, the parent template manufacturing date 640g, the parent template processing treatment 640h and the cleaning number of parent template 640i are corresponding to the child template manufacturing date 880b, the parent template name 880c, the parent template manufacturing date 880d, the parent template processing treatment 880e and the cleaning number of parent template 880f of the managing information 880A of the child template set to the imprint device.

The control part 68 is configured, for example, to include a CPU, a RAM, a ROM and the like. The control part 68 is configured, for example, to manage the parent template and the child templates based on the system managing information 640 or the managing information 880A.

Hereinafter, a method of manufacturing a parent template according to the embodiment will be explained.

### Manufacturing Method of Parent Template

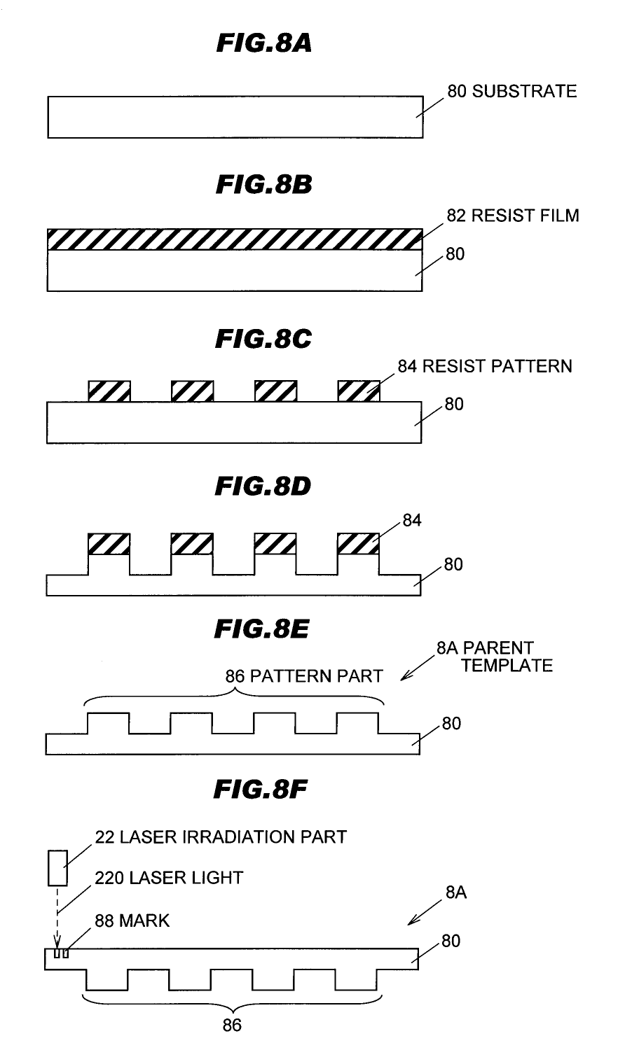

FIGS. 8A to 8F are cross-sectional views schematically showing the primary portions of manufacturing processes of a parent template according to the first embodiment. Manufacturing of the parent template 8A described below is carried out, for example, in the template forming part 20 of the template forming device 2.

First, as shown in FIG. 8A, the substrate 80 is prepared. The substrate 80 is, for example, a Si substrate including Si as a main component.

Next, as shown in FIG. 8B, the resist film 82 is formed on the substrate 80, for example, by a spin coat method or the like.

Next, as shown in FIG. 8C, the resist pattern 84 is formed, for example, by an electron beam lithography method or the like.

Next, as shown in FIG. 8D, the substrate 80 is etched by using the resist pattern 84 as a mask, for example, by a reactive ion etching (RIE) method or the like.

Next, as shown in FIG. 8E, the resist pattern 84 is removed so as to form the pattern part 86, and the parent template 8A is obtained.

Next, the managing information 880A configured to include the parent template name 880c, the parent template manufacturing date 880d, and the parent template processing treatment 880e is produced by the managing information producing part 21, and is transmitted to the laser irradiation part 22 via the control part 25.

Next, as shown in FIG. 8F, the mark 88 is formed in the parent template 8A. Particularly, first, the substrate 80 is turned upside down. Subsequently, the parent template 8A is irradiated with the laser light 220 from the laser irradiation part 22 based on the managing information 880A transmitted from the managing information producing part 21. Subsequently, the mark 88 is formed in a region out of the pattern part 86 so as to obtain the parent template 8A having the mark 88.

Here, the mark 88 is formed of, for example, a one-dimensional code that information is aligned in a transverse direction, a two dimensional code that information is aligned in a longitudinal direction and a transverse direction or a picture image.

Hereinafter, a method of manufacturing a child template according to the embodiment will be explained.

### Manufacturing Method of Child Template

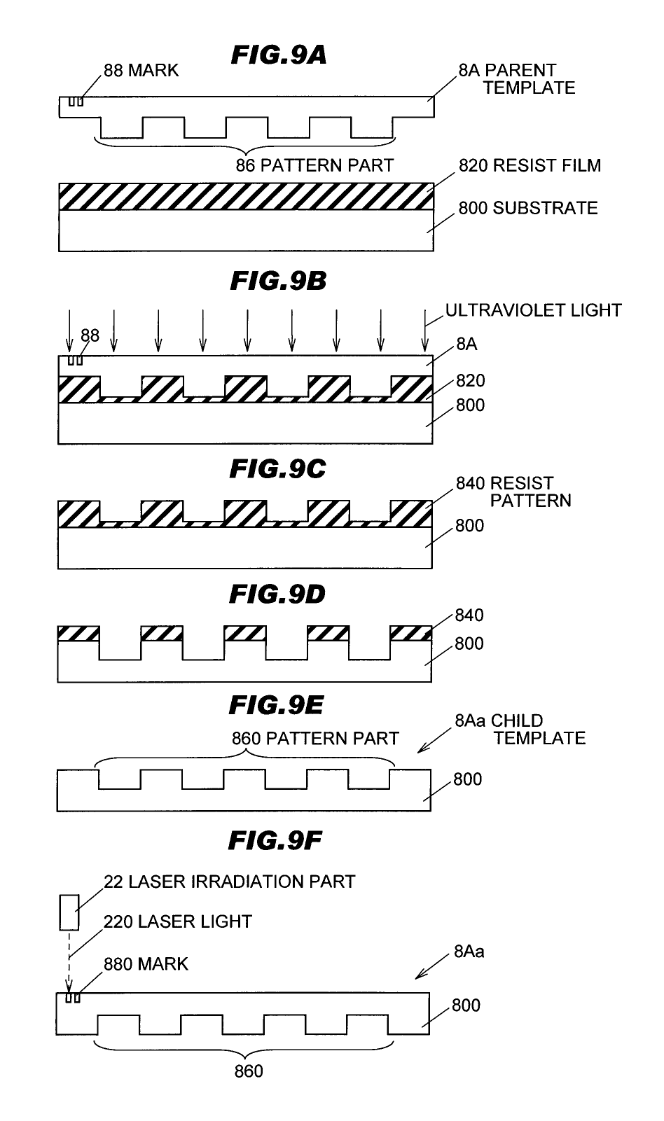

FIGS. 9A to 9F are cross-sectional views schematically showing the primary portions of manufacturing processes of the child template according to the first embodiment. Manufacturing of the child template 8Aa described below is carried out, for example, in the template forming part 20 of the template forming device 2.

First, as shown in FIG. 9A, the resist film 820 is formed on the substrate 800, for example, by a spin coat method or the like. Subsequently, the parent template 8A and the substrate 800 are aligned with each other.

Next, the parent template 8A is brought into contact with the resist film 820 and the resist is filled into a concave portion of the pattern part 86 of the parent template 8A.

Next, as shown in FIG. 9B, the resist film 820 is irradiated with ultraviolet light via the parent template 8A. The resist film 820 is hardened due to the irradiation of ultraviolet light.

Next, as shown in FIG. 9C, after the resist film 820 is hardened due to the irradiation of ultraviolet light, the parent template 8A and the substrate 800 are separated from each other, so as to form the resist pattern 840.

Next, as shown in FIG. 9D, the resist pattern 840 is etched back by the film thickness in the bottom portion of the concave portion of the resist pattern 840, for example, by a RIE method or the like, so that the substrate 800 is exposed in the concave portion. Subsequently, the substrate 800 exposed in the concave portion is etched by a RIE method or the like.

Next, as shown in FIG. 9E, the resist pattern 840 is removed so as to form the pattern part 860, and the child template 8Aa is obtained.

Next, the managing information 880A is produced by the managing information producing part 21, and is transmitted to the laser irradiation part 22 via the control part 25.

Next, as shown in FIG. 9F, the mark 880 is formed in the child template 8Aa. In particular, first, the substrate 800 is turned upside down. Subsequently, the child template 8Aa is irradiated with the laser light 220 from the laser irradiation part 22 based on the managing information 880A transmitted from the managing information producing part 21. Subsequently, the mark 880 is formed in a region out of the pattern part 860 so as to obtain the child template 8Aa having the mark 880.

Via the above-mentioned steps, a plurality of the child templates 8Aa are manufactured from the parent template 8A. Further, the mark 88 of the parent template 8A and the mark 880 of the child template 8Aa can be also formed, for example, by that the marks 88, 880 are printed to the parent template 8A and the child template 8Aa.

Hereinafter, a method of manufacturing of a semiconductor device by using the child template according to the embodiment will be explained.

### Manufacturing Method of Semiconductor Device

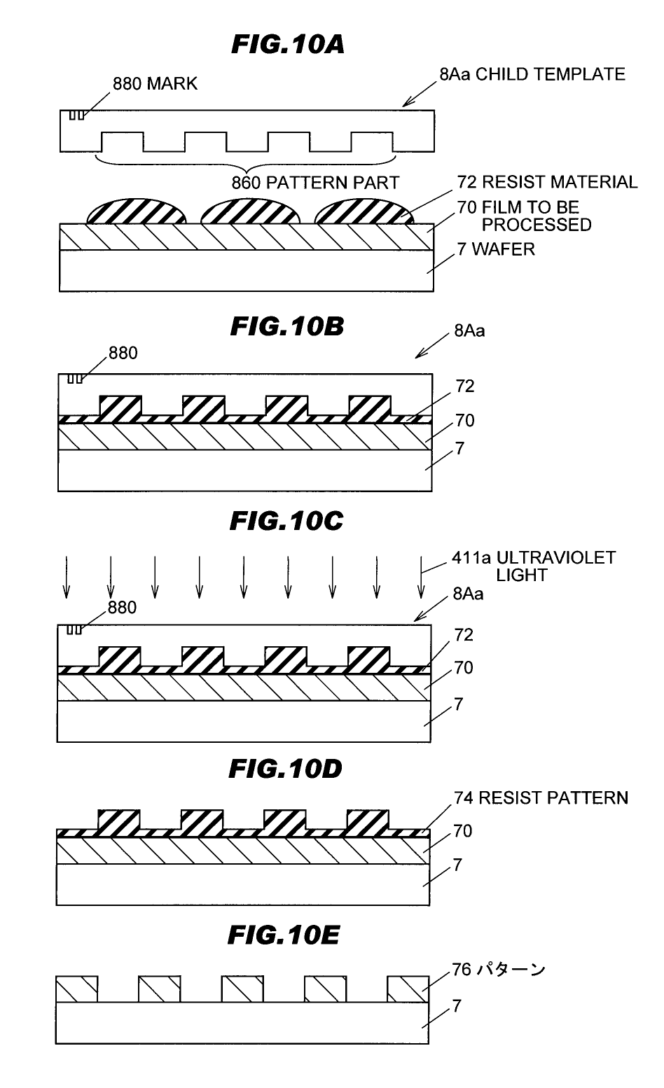

FIGS. 10A to 10E are cross-sectional views schematically showing the primary portions of processes of manufacturing method of a semiconductor device according to the first embodiment. Manufacturing of the semiconductor device described below is carried out, for example, in the first imprint device 4A.

First, the control part 46 of the first imprint device 4A reads out the mark 880 of the child template 8Aa set, via the reading part 412, so as to obtain the managing information 880A. Subsequently, the wafer 7 is fixed to the chuck 405 of the imprint processing part 40. In the wafer 7, the film to be processed 70 is formed.

Next, as shown in FIG. 10A, for example, the resist material 72 having a droplet-like shape is disposed on the film to be processed 70, that is formed the wafer 7 is fixed to the chuck 405 of the imprint processing part 40. For example, the resist material 72 is disposed on the film to be processed 70 so that each droplet has the same volume. Further, the film to be processed 70 can be, for example, a single film or a stacked film formed of a plurality of films.

Next, the child template 8Aa is fixed to the template chuck 410 so that the pattern part 860 of the child template 8Aa is located in a side of the XY stage 404. Subsequently, the child template 8Aa and the wafer 7 are opposed to each other.

Next, as shown in FIG. 10B, the pattern part 860 of the child template 8Aa and the resist material 72 disposed on the film to be processed 70 are brought into contact with each other.

Next, the child template 8Aa and the wafer 7 are aligned with each other.

Next, as shown in FIG. 10C, after the alignment of the child template 8Aa and the wafer 7 is completed, the resist material 72 is irradiated with the ultraviolet light 411a from the irradiation part 411 via the upper stage 406, the template chuck 410 and the child template 8Aa.

Next, as shown in FIG. 10D, the resist pattern 74 is formed. In particular, the resist material 72 is hardened due to the irradiation of the ultraviolet light 411a. Subsequently, when the actuator 408 is driven so that the upper stage 406 is elevated, the resist pattern 74 that is a transfer pattern of the pattern part 860 formed in the child template 8Aa is formed on the film to be processed 70.

Next, as shown in FIG. 10E, the resist pattern 74 is etched back by the film thickness in the bottom portion of the concave portion of the resist pattern 74, for example, by a RIE method or the like, so that the film to be processed 70 is exposed in the concave portion. Subsequently, the film to be processed 70 exposed in the concave portion is etched by a RIE method or the like. Subsequently, remaining resist pattern 74 is removed and the pattern 76 (for example, a magnetic domain pattern of HDD, a semiconductor circuit of memory, or the like) including the film to be processed 70 is formed.

Next, the inspection part 415 inspects the pattern 76 and transmits the inspection result to the control part 46. The control part 46 stores the obtained inspection result in the processed wafer 421c of the imprint information 421 via the memory part 42, and renews the imprint information 421.

In addition, the control part 46 transmits the managing information 880A and the imprint information 421 to the managing device 6 via the network 5 and the communication part 66, for example, after the processing of the predetermined number (for example, one lot) of the wafer is completed.

The control part 68 of the managing device 6 renews the system managing information 640 based on the managing information 880A and the imprint information 421 obtained via the communication part 66.

Subsequently, well-known steps are carried out to the wafers 7 that are recognized as good products due to the result of inspection, so as to obtain a desired semiconductor device.

Hereinafter, a method of forming and managing a template based on the template forming and managing system 1 according to the embodiment will be explained.

### Action of Template Forming and Managing System

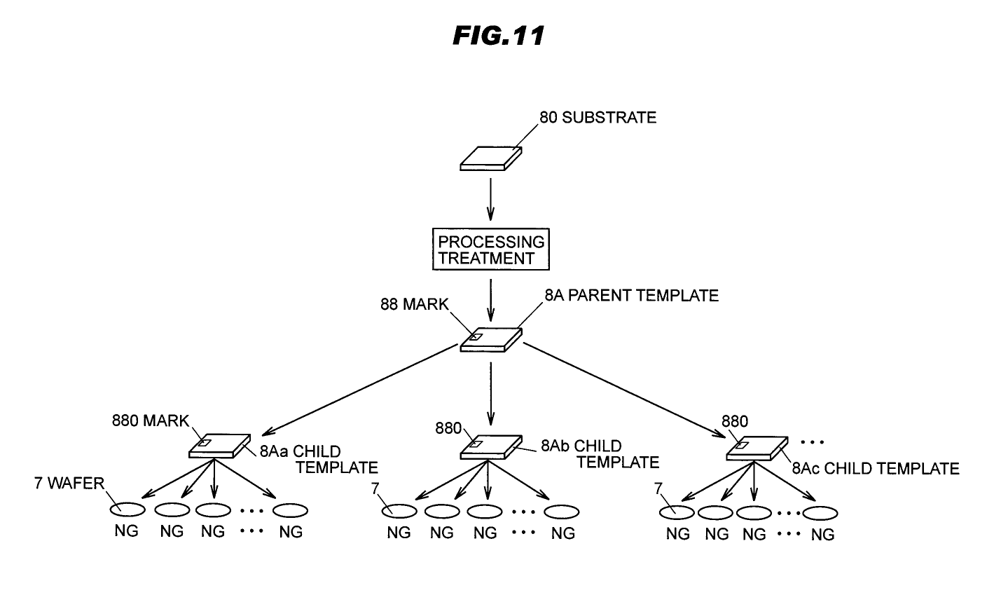

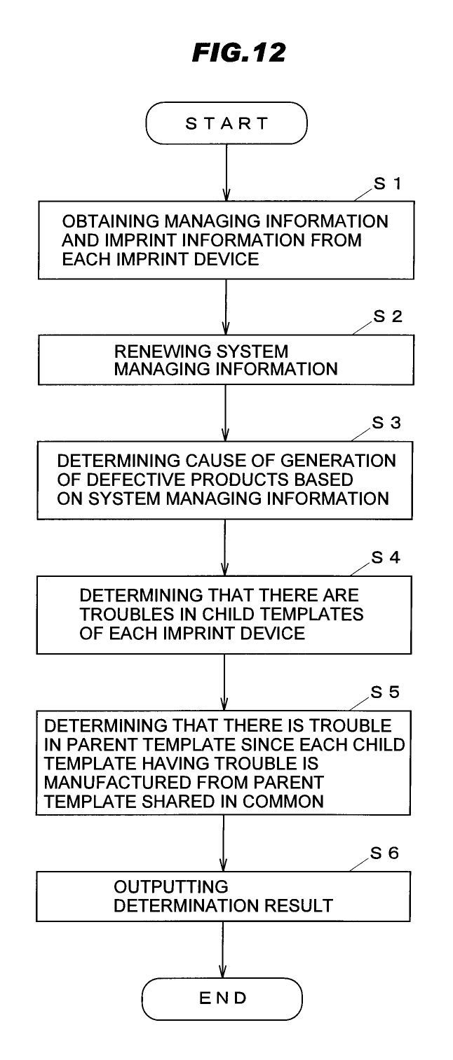

FIG. 11 is an explanatory view schematically showing a relationship between the parent template and the child template according to the first embodiment. Hereinafter, a case that the child template 8Aa manufactured from the parent template 8A is set to the first imprint device 4A, a case that the child template 8Ab manufactured from the parent template 8A is set to the first imprint device 4B, and a case that the child template 8Ac manufactured from the parent template 8A is set to the first imprint device 4C will be explained according to the flowchart of FIG. 12. Further, “NG” in FIG. 11 shows that the wafer 7 processed is a defective product.

First, each control part of the first to the third imprint devices 4A to 4C obtains each mark 880 of the child templates 8Aa, 8Ab, 8Ac set via each reading part, so as to obtain each managing information 880A. Subsequently, as shown in FIG. 11, each of the first to the third imprint devices 4A to 4C processes the wafer 7 according to the above-mentioned manufacturing method of the semiconductor device.

Next, each inspection part of the first to the third imprint devices 4A to 4C inspects the wafer 7 processed. Each inspection part renews the imprint information 421 based on the inspection result.

Next, each control part of the first to the third imprint devices 4A to 4C outputs each managing information 880A and each imprint information 421 via the communication part.

The control part 68 of the managing device 6 obtains the managing information 880A and the imprint information 421 via the communication parts of the first to the third imprint devices 4A to 4C, the network 5 and the communication part 66 (S1). Subsequently, the system managing information 640 is renewed based on the managing information 880A and the imprint information 421 (S2).

Since defective products are sequentially generated in the wafers 7 processed by the first to the third imprint devices 4A to 4C based on the imprint information 421 obtained, the control part 68 of the managing device 6 determines the cause of generation of defective products (S3).

First, the control part 68 of the managing device 6 determines that there are troubles in the child templates 8Aa to 8Ac of the first to the third imprint devices 4A to 4C, since defective products are sequentially generated in the first to the third imprint devices 4A to 4C (S4).

Next, the control part 68 refers to the parent template name 640f associated with the child templates 8Aa to 8Ac determined that there are troubles. As a result of the reference, the control part 68 determines that there is trouble in the parent template 8A, since the child templates 8Aa to 8Ac having troubles are manufactured from the parent template 8A shared in common (S5).

Next, the control part 68, for example, outputs the determination result to the outputting part 62 (S6), and completes the determination.

### Second Embodiment

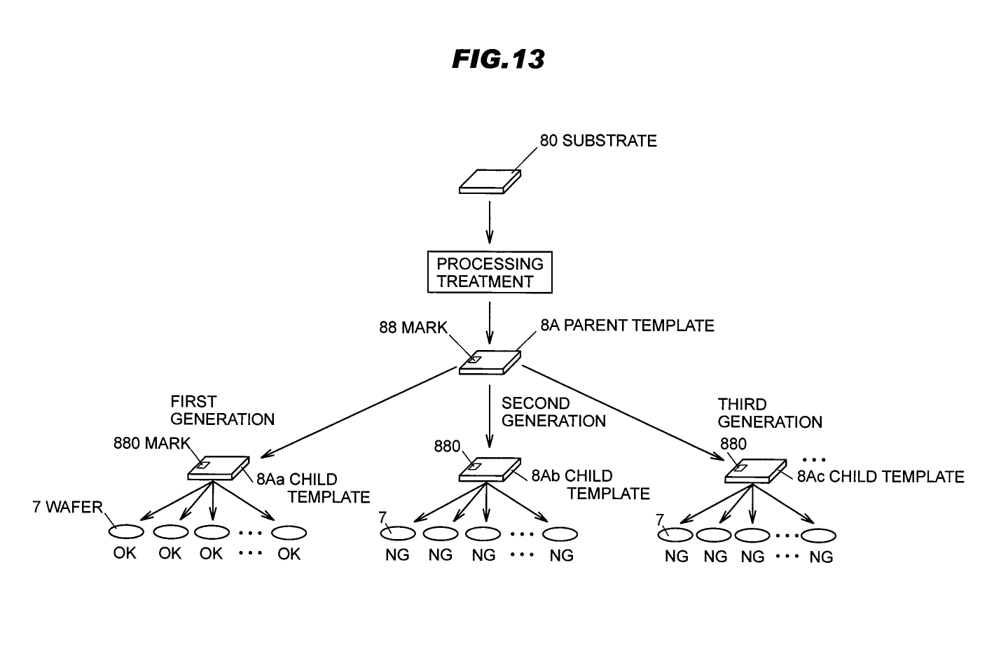

FIG. 13 is an explanatory view schematically showing a relationship between the parent template and the child template according to a second embodiment. Further, in the embodiment, the first child template 8Aa manufactured from the parent template 8A is described as the first generation, the second child template 8Ab is described as the second generation and the third child template 8Ac is described as the third generation, but not limited to this, the Nth child template 8An is described as the first generation.

The template forming and managing system 1 in each embodiment described below is configured to have the same composition. Consequently, in each embodiment described below, the same references will be used to elements that have the same compositions and functions as elements in the first embodiment have, and detail explanation will be omitted.

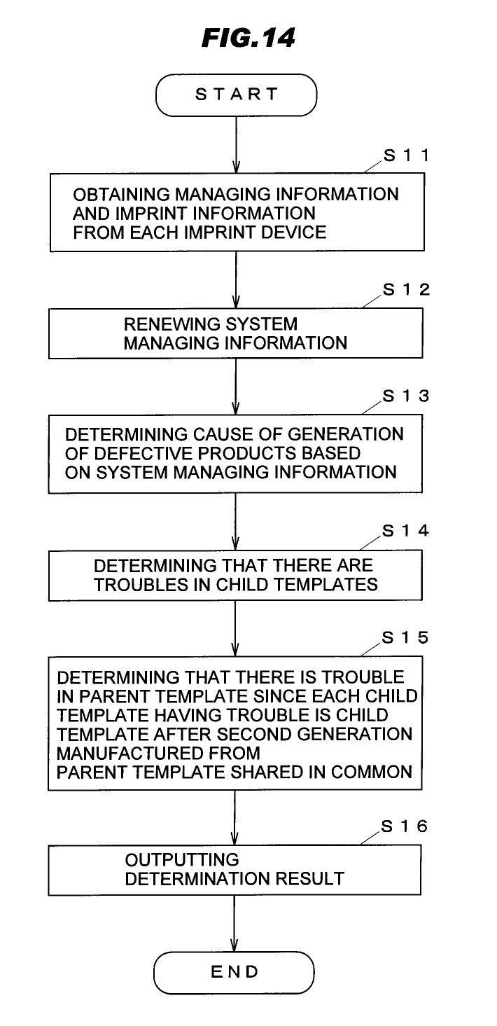

Hereinafter, a method of forming and managing a template based on the template forming and managing system 1 according to the embodiment will be explained in accordance with the flowchart of FIG. 14.

In the embodiment, the first generation child template 8Aa manufactured from the parent template 8A is set to the first imprint device 4A. The second generation child template 8Ab manufactured from the parent template 8A is set to the second imprint device 4B. The third generation child template 8Ac manufactured from the parent template 8A is set to the third imprint device 4C.

First, each control part of the first to the third imprint devices 4A to 4C obtains each mark 880 of the child templates 8Aa, 8Ab, 8Ac set via each reading part, so as to obtain each managing information 880A. Subsequently, as shown in FIG. 13, each of the first to the third imprint devices 4A to 4C processes the wafer 7 according to the above-mentioned manufacturing method of the semiconductor device.

Next, each inspection part of the first to the third imprint devices 4A to 4C inspects the wafer 7 processed. Each inspection part renews the imprint information 421 based on the inspection result.

Next, each control part of the first to the third imprint devices 4A to 4C outputs each managing information 880A and each imprint information 421 via the communication part.

The control part 68 of the managing device 6 obtains the managing information 880A and the imprint information 421 via the communication parts of the first to the third imprint devices 4A to 4C, the network 5 and the communication part 66 (S11). Subsequently, the system managing information 640 is renewed based on the managing information 880A and the imprint information 421 (S12).

Since defective products are sequentially generated in the wafers 7 processed by the second and the third imprint devices 4B, 4C based on the imprint information 421 obtained, the control part 68 of the managing device 6 determines the cause of generation of defective products based on the system managing information 640 (S13).

First, the control part 68 of the managing device 6 determines that there are troubles in the child templates 8Ab, 8Ac of the second and the third imprint devices 4B, 4C, since defective products are sequentially generated in the second and the third imprint devices 4B, 4C (S14).

Next, the control part 68 refers to the parent template name 640f associated with the child templates 8Ab, 8Ac determined that there are troubles. As a result of the reference, the control part 68 determines that there is trouble in the parent template 8A, since the child templates 8Ab, 8Ac are the first generation and the second generation child templates manufactured from the parent template 8A shared in common (S15).

Next, the control part 68, for example, outputs the determination result to the outputting part 62 (S16), and completes the determination.

### Third Embodiment

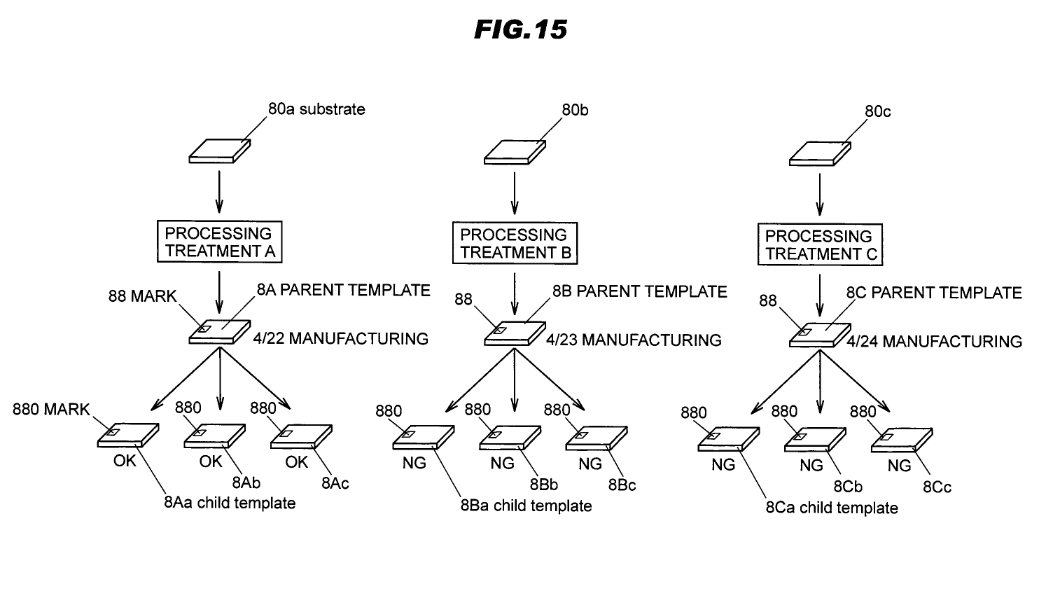

FIG. 15 is an explanatory view schematically showing a relationship between the parent template and the child template according to a third embodiment. As shown in FIG. 15, each of the parent templates 8A, 8B, 8C is manufactured by the different processing treatment from each other.

“OK” in FIG. 15 shows that the child templates 8Aa, 8Ab, 8Ac are good products and “NG” shows that the child templates 8Ba, 8Bb, 8Bc 8Ca, 8Cb, 8Cc are defective products. The determination of good products and defective products is carried out based on the inspection after being manufactured from the parent template.

The parent template 8A is manufactured from the substrate 80a by the processing treatment A. The parent template 8B is manufactured from the substrate 80b by the processing treatment B. The parent template 8C is manufactured from the substrate 80c by the processing treatment C.

Here, the processing treatment A, the processing treatment B and the processing treatment C are different from each other.

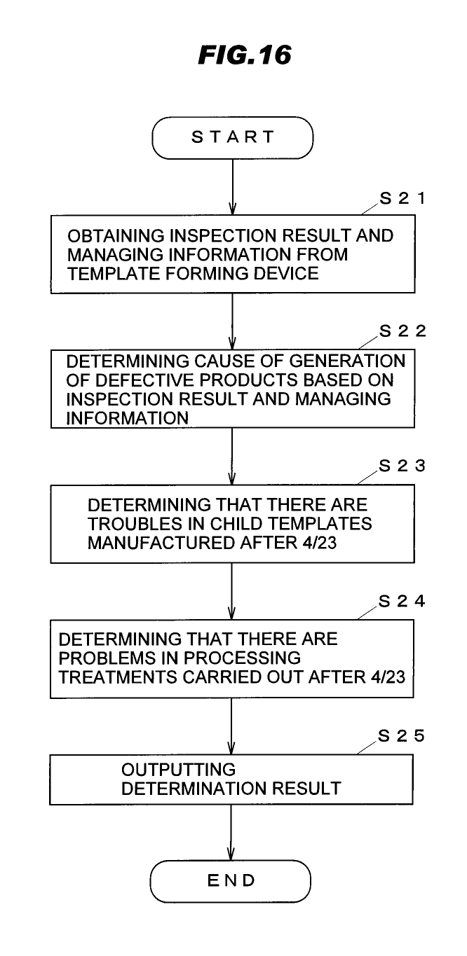

Hereinafter, a method of forming and managing a template based on the template forming and managing system 1 according to the embodiment will be explained in accordance with the flowchart of FIG. 16.

First, the inspection part 24 sequentially inspects the child templates 8Aa, 8Ab, 8Ac 8Ba, 8Bb, 8Bc 8Ca, 8Cb, 8Cc manufactured from the parent templates 8A, 8B, 8C.

Next, the inspection part 24 reads out each mark 880 of the child templates 8Aa, 8Ab, 8Ac 8Ba, 8Bb, 8Bc 8Ca, 8Cb, 8Cc, so as to obtain each managing information 880A.

Next, the inspection part 24 outputs the inspection result of the child templates 8Aa, 8Ab, 8Ac 8Ba, 8Bb, 8Bc 8Ca, 8Cb, 8Cc and the managing information 880A via communication part 26.

The control part 68 of the managing device 6 obtains the inspection result and the managing information 880A via the network 5 and the communication part 66 (S21). Since defective products are sequentially generated in the child templates 8Ba, 8Bb, 8Bc 8Ca, 8Cb, 8Cc, the control part 68 of the managing device 6 determines the cause of generation of defective products based on the inspection result and the managing information 880A obtained (S22).

First, the control part 68 refers to each parent template name 880c associated with the child templates 8Ba, 8Bb, 8Bc 8Ca, 8Cb, 8Cc determined that there are troubles. As a result of the reference, the control part 68 determines that there are troubles in the child templates that are manufactured after 4/23 from the parent template manufacturing date 880d (S23).

Subsequently, the control part 68 determines that there are problems in the processing treatments carried out after 4/23, since the processing treatments are different from each other from the parent template processing treatment 880e (S24).

Next, the control part 68, for example, outputs the determination result to the outputting part 62 (S25), and completes the determination.

### Fourth Embodiment

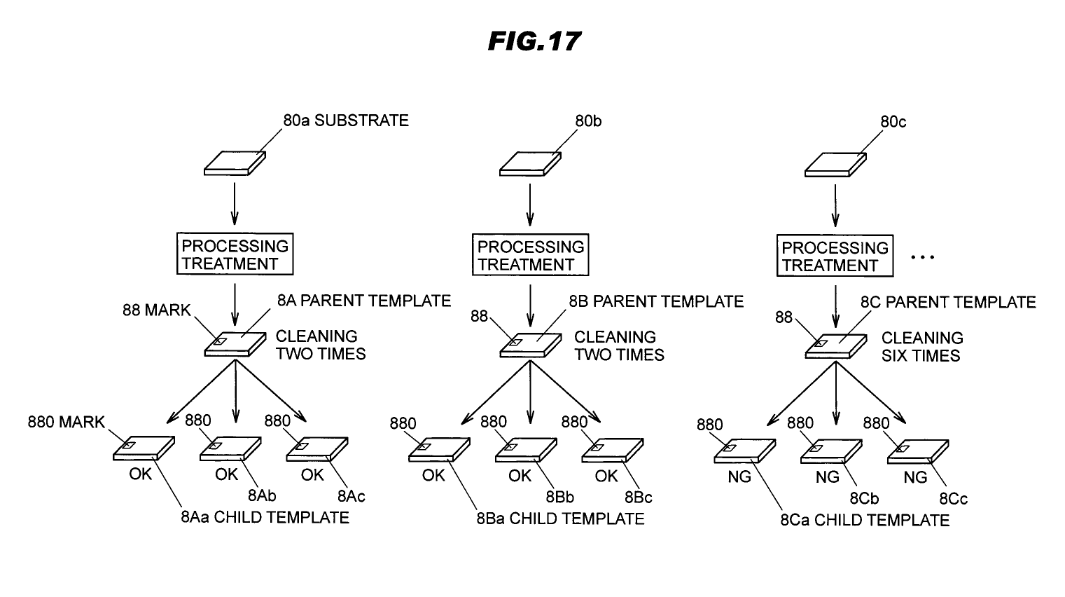

FIG. 17 is an explanatory view schematically showing a relationship between the parent template and the child template according to a fourth embodiment. In the embodiment, the parent templates 8A, 8B, 8C are manufactured by the same processing treatment, but number of cleaning when the child template is manufactured is different from each other.

By the same processing treatment, the parent template 8A is manufactured from the substrate 80a, the parent template 8B is manufactured from the substrate 80b, and the parent template 8C is manufactured from the substrate 80c.

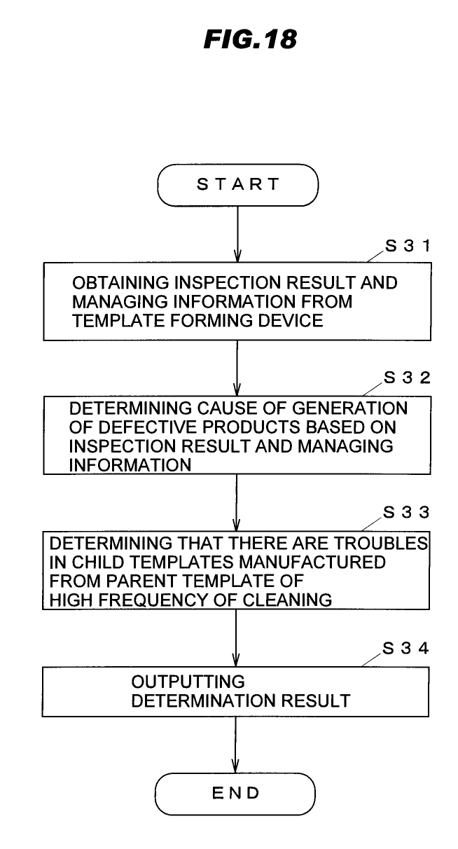

Hereinafter, a method of forming and managing a template based on the template forming and managing system 1 according to the embodiment will be explained in accordance with the flowchart of FIG. 18.

First, the inspection part 24 sequentially inspects the child templates 8Aa, 8Ab, 8Ac 8Ba, 8Bb, 8Bc 8Ca, 8Cb, 8Cc manufactured from the parent templates 8A, 8B, 8C.

Next, the inspection part 24 reads out each mark 880 of the child templates 8Aa, 8Ab, 8Ac 8Ba, 8Bb, 8Bc 8Ca, 8Cb, 8Cc, so as to obtain each managing information 880A.

Next, the inspection part 24 outputs the inspection result of the child templates 8Aa, 8Ab, 8Ac 8Ba, 8Bb, 8Bc 8Ca, 8Cb, 8Cc and the managing information 880A via communication part 26.

The control part 68 of the managing device 6 obtains the inspection result and the managing information 880A via the network 5 and the communication part 66 (S31). Since defective products are sequentially generated in the child templates 8Ba, 8Bb, 8Bc 8Ca, 8Cb, 8Cc, the control part 68 of the managing device 6 determines the cause of generation of defective products based on the inspection result and the managing information 880A obtained (S32).

First, the control part 68 compares a plurality of the managing information 880A obtained, and determines that there are troubles in the child templates manufactured from the parent template of which the cleaning number of parent template 880f is high (S33).

Next, the control part 68, for example, outputs the determination result to the outputting part 62 (S34), and completes the determination.

According to the above-explained embodiments, the mark including the managing information is formed in the child template, so that the managing information about the parent template included in the mark formed in the child template can be read out, and the parent template and the child template can be managed in comparison with a case that the mark including the managing information is not formed in the child template.

While certain embodiments have been described, these embodiments have been presented by way of example only, and not intended to limit the scope of inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the template forming and managing system 1 can be configured to be one device.

For example, in the above-mentioned embodiments, a case that a plurality of the imprint devices as the template forming and managing system 1 are connected has been explained. However, the method of forming and managing a template can be configured to have a composition that there are a plurality of the imprint processing parts in one imprint device, the marks 880 of the child templates set to the plural imprint processing parts are read out, and each processing is carried out based on the managing information 880A read out.

In addition, a composition can be also adopted, that the above-mentioned method of forming and managing a template is used in one imprint device having one imprint processing part. This case is used for, for example, a case that the child templates are replaced due to the fact that defective products are generated in the wafers 7 processed, but the state is not improved by the replacement of the child templates. Since the marks 880 including the managing information 880A are formed in the child templates, the cause can be determined more accurately in comparison with a case that the marks are not formed.

The items of the managing information 880A are not limited to the above-mentioned embodiments, for example, kind of processing treatment of the child template, kind and number of cleaning treatment of the child template, kind of cleaning treatment of the parent template, and cleaning date of the parent template and child template can be added thereto. The same is true of the imprint information 421 and the system managing information 640.

What is claimed is:

1. A method of forming and managing a template, comprising:
forming a child template using a parent template and producing managing information about the parent template; and
forming a mark including the managing information in the child template.

2. The method of forming and managing a template according to claim 1, further comprising:
after forming the mark, reading out the mark of the child template and obtaining the managing information;
performing an imprint processing to a workpiece by using the child template;
inspecting the workpiece to which the imprint processing is performed; and
managing the parent template and the child template based on an inspection result of the workpiece and the managing information read out.

3. The method of forming and managing a template according to claim 2, wherein the managing information includes a identification information for identifying the parent template, and
when a trouble is discovered in the workpiece by the inspection, the managing determines that the parent template has a trouble based on the identification information in the mark of the child template.

4. The method of forming and managing a template according to claim 2, wherein the plural of the child templates is formed by using the parent template, the managing information includes a identification information for identifying the parent template and a time and date information about time and date when the child template is formed, and
when a trouble is discovered in at least one of the workpieces by the inspection, the managing identifies a generation of the child template which performed the imprint processing to the workpiece having trouble based on the identification information and the time and date information,
determining whether the parent template has a trouble.

5. The method of forming and managing a template according to claim 3, wherein the managing information includes a time and date information about time and date when the parent template is formed, and
when the trouble is discovered in the workpiece by the inspection, the managing identifies a date and time when the parent template is made based on the time and date information in the mark of the child template.

6. The method of forming and managing a template according to claim 3, wherein the managing information includes a processing treatment information about a processing treatment which is carried out to the parent template, and
when the trouble is discovered in the workpiece by the inspection, the managing identifies the processing treatment which is carried out to the parent template based on the processing treatment information in the mark of the child template.

7. The method of forming and managing a template according to claim 3, wherein the managing information includes a number of cleaning information about number of cleaning which is carried out to the parent template, and
when the trouble is discovered in the workpiece by the inspection, the managing identifies a number of the cleaning which is carried out to the parent template based on the number of cleaning information in the mark of the child template.

8. The method of forming and managing a template according to claim 1, wherein the mark is formed by using a laser light.

9. The method of forming and managing a template according to claim 3, wherein the mark is formed by using a laser light.

10. The method of forming and managing a template according to claim 1, wherein the mark is formed in side surfaces of the child template, regions in main surfaces of the child template where patterns are formed except for the patterns, and in regions that correspond to regions in rear surfaces of the child template except for the patterns.

11. The method of forming and managing a template according to claim 3, wherein the mark is formed in side surfaces of the child template, regions in main surfaces of the child template where patterns are formed except for the patterns, and in regions that correspond to regions in rear surfaces of the child template except for the patterns.

12. The method of forming and managing a template according to claim 8, wherein the mark is formed in side surfaces of the child template, regions in main surfaces of the child template where patterns are formed except for the patterns, and in regions that correspond to regions in rear surfaces of the child template except for the patterns.

13. The method of forming and managing a template according to claim 1, wherein the mark is formed of a one-dimensional code, a two dimensional code or a picture image.

14. The method of forming and managing a template according to claim 3, wherein the mark is formed of a one-dimensional code, a two dimensional code or a picture image.

15. The method of forming and managing a template according to claim 12, wherein the mark is formed of a one-dimensional code, a two dimensional code or a picture image.

16. A template, comprising:
mark including managing information about a parent template as a mold for forming the template.

17. The template according to claim 16, wherein the mark is formed in side surfaces of the child template, regions in main surfaces of the child template where patterns are formed except for the patterns, and in regions that correspond to regions in rear surfaces of the child template except for the patterns.

18. The template according to claim 16, wherein the mark is formed of a one-dimensional code, a two dimensional code or a picture image.

19. A template forming and managing device, comprising:
a template forming part configured to form a child template from a parent template;
a managing information producing part configured to produce managing information about the parent template, and
a mark forming part configured to form a mark including the managing information in the child template.

20. The template forming and managing device according to claim 19, further comprising:
an obtaining part configured to read out the mark of the child template so as to obtain the managing information;
an imprint processing part configured to perform an imprint processing to a workpiece by using the child template,
an inspection part configured to inspect the workpiece which performed the imprint processing; and
a managing part configured to manage the parent template and the child template based on an inspection result of the workpiece and the managing information read out.
